(19) United States
(12) Patent Application Publication
(10) Pub. No.: US 2009/0258250 A1
(43) Pub. Date: Oct. 15, 2009

(54) Balanced Composition Hardfacing Alloy

(75) Inventors: Roger Auguste Daemen, Troy, OH (US); Keith E. Moline, Houston, TX (US)

Correspondence Address: STRASBURGER & PRICE, LLP;ATTN: IP SECTION, 1401 MCKINNEY, SUITE 2200, HOUSTON, TX, 77010, US

(73) Assignee: ATT Technology, Ltd. d/b/a Amco Technology Trust, Ltd., Houston, TX (US)

(21) Appl. No.: 12/456,465

(22) Filed: Jun. 17, 2009

Related U.S. Application Data
(63) Continuation-in-part of application No. 12/075,386, filed on Mar. 10, 2008, now Pat. No. 7,569,286.
Application No. 12/075,386 is a continuation of application No. 10/419,713, filed on Apr. 21, 2003, now Pat. No. 7,361,411.

(51) Int. Cl. B32B 15/00; C22C 38/00; C22C 38/08; B23K 28/00

(52) U.S. Cl. 428/684; 420/99; 420/119; 228/101

(57) ABSTRACT

An iron based hardfacing alloy with an undiluted (all weld material) alloy composition is substantially balanced in order to achieve an hypo-eutectic primary austenitic with secondary martensitic solidification mode. The alloy enables the deposition of substantially crack-free single layers of hardfacing onto industrial components without any post weld treatment. The hardfacing alloy is capable of withstanding abrasion of silicious earth particles when applied to industrial products, such as tool joints, stabilizers and casing and other tubulars used in oil and gas well drilling, and other industrial products.

### CROSS-REFERENCE TO RELATED APPLICATIONS

This application is a continuation-in-part of co-pending U.S. application Ser. No. 12/075,386 filed on Mar. 10, 2008, which is a continuation of U.S. application Ser. No. 10/419,713 filed on Apr. 21, 2003, now U.S. Pat. No. 7,361,411, all of which applications are hereby incorporated by reference for all purposes in their entirety and are assigned to the assignee of the present invention.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention is in the field of hardfacing alloys having high abrasion resistance for improving the service life of surfaces of industrial products subject to abrasion and wear, such as tool joints, drill collars, and stabilizers used in drilling strings for earth boring for oil and gas.

2. Description of the Related Art

Approximately 95 percent of the surface of the earth is composed of silicious materials that are abrasive and cause considerable wear on the surfaces of tool joints and stabilizers, as well as on tubulars such as casings, and other industrial products. There has been a concern with the service life of tool joints and stabilizers, as well as with tubulars such as casings, used in earth boring such as drilling a bore hole in the earth to a formation or formations from which oil or gas are to be produced.

There have been numerous attempts to provide hardfacing alloys suitable for welding protective hardfacing (sometimes referred to as “hardbanding”) on tool joints. For a description of prior art hardbanding of tool joints, reference is made to U.S. Pat. No. 4,256,518; the Composite Catalog of Oil Field Equipment and Services, 1976/77 Edition, at pages 3216-19 and pages 4994-5; and U.S. Pat. No. 3,067,593. Also, for the use of hardfacing materials, such as tungsten carbide particles to form a hardened surface at a tool joint to increase wear resistance, reference is made to U.S. Pat. No.3,989,554, and the History of Oil Well Drilling by J. E. Brantly published in 1971 by the book division of Gulf Publishing Company, Houston, Tex. Also, reference is made to U.S. Pat. Nos. 2,259,232; 2,262,211; 4,431,902; and 4,942,059 which illustrate various prior art ways to hardband tool joints.

Historically, and in practice, tool joints on drilling strings (pipe) such as used in drilling oil and gas wells have been faced at the bottom of the box end with tungsten carbide to resist the abrasion of the rock earth in the drill hole on the tool joint. This has three disadvantages. Tungsten carbide is expensive, it acts as a cutting tool to cut the well casing in which it runs, and the matrix is a soft steel which erodes away easily to allow the carbide particles to fall away.

Some prior art hardfacing materials harder than silicious earth materials are brittle and crack in a brittle manner after solidification and upon cooling due to the brittle nature of their structure and the inability of the structure to withstand solidification shrinkage stresses. The materials typically emit sound energy upon cracking as well as cause considerable casing wear. These hardfacing materials are alloys that belong to a well-known group of “high Cr Irons” (high Chromium Irons), and their high abrasive resistance is derived from the presence in the microstructure of the Cr-carbides of the eutectic and/or hypereutectic type. In the as-welded condition, whatever the precautions taken, these hardfacing overlays always show a more or less dense network of cracks. Preheat of the base material being hardfaced is not a prerequisite. On the contrary, the lower the preheat and interpass temperatures, the denser the network of cracks which has been considered as a favorable factor from the point of view of the risk of crack propagation into the base material under service conditions.

When hardbanding tool joints or stabilizers of drilling pipe, no facing which cracked during application to the drilling pipe was used prior to the development of the invention in U.S. Pat. No. 6,375,895, which includes preheat and post-welding conditions for the hardfacing to withstand abrasive use. In most industries, however, the metal components which make up the structure and equipment of a given plant must have integrity, which means being free of any kind of cracks since these might be expected to progress through the piece and destroy the part. When the loss of human life may be involved or when great property damage may result, the requirements for integrity are particularly strict.

Silicious earth particles have a hardness of about 800 Brinell hardness number (BHN). In U.S. Pat. No. 5,244,559 the hardfacing material used is of the group of high Cr-Irons that contains primary carbides which have a hardness of about 1700 Hv in a matrix of a hardness of at least 300 BHN to 600 Hv. These primary carbides at this high hardness are brittle, have little tensile strength and hence pull apart on cooling from molten state at a frequency that depends on the relative quantity of the primary carbides in the mix of metal and carbide. Thus, this type of hardfacing material, which is harder than silicious earth materials, when applied by welding or with bulk welding form shrinkage cracks across the weld bead. This material has been applied extensively and successfully during many years for the hardbanding of tool joints and other industrial products. Although the material has become and still is widely accepted by the trade, some users have expressed a desire for a hardfacing tool joint alloy combining the property of minimum possible amount of wear in drill casing with the capability of being welded free of brittle cracks in order to minimize any concerns of mechanical failure risks.

U.S. Pat. No. 6,375,895 describes an alloy having a Martensitic-Austenitic microstructure from which primary as well as secondary carbides are absent. It is preheated before welding to the industrial product and cooled down after welding.

Wear by abrasion mechanisms always has been, and still remains a main concern in many segments of industry: drilling, mining, quarrying, processing and handling of minerals in general and of highly silicious minerals in particular. Many base materials and hardfacing alloys have been developed in the past with the aim of achieving the highest possible abrasion resistance compatible with factors such as their decay by mechanical incidences: ruptures and/or spalling. Typical examples of very highly abrasion resistant hardfacing alloys can be found in the well known family of the high Chromium Irons, and in particular by a high Cr-Iron such as described in U.S. Pat. No. 5,244,559.

These alloys derive their abrasion resistance properties essentially from their metallographical structure, based on the precipitation of primary Cr-carbides. Structures of this type are however affected by a high degree of brittleness and a high sensitivity to cracking when deposited by welding. Hence they exhibit quite a high risk of spalling under actual service conditions. In addition they are not characterized by particularly attractive or low friction coefficients.

Considering the drilling for oil and gas application, in order to reduce the wear induced in the casings by the tool joints, attempts have been made to improve on friction coefficients while maintaining a reasonable and acceptable level of abrasive wear resistance. These efforts have resulted in the development of a Martensitic-Austenitic alloy as described in U.S. Pat. No. 6,375,895. Alloys of this structural type can be deposited crack-free and are characterized by excellent metal to metal wear properties and low brittleness. Hence their susceptibility to spalling is much reduced, however at the expense of a lower resistance against wear by pure abrasion.

U.S. Pat. No. 7,487,840 proposes a method and related alloy having Boron to provide a protective wear coating on a downhole component through a thermal spraying process.

The above discussed U.S. Pat. Nos. 2,259,232; 2,262,211; 3,067,593; 3,989,554; 4,256,518; 4,431,902; 4,942,059; 5,244,559; 6,375,895; 7,361,411; and 7,487,840 are hereby incorporated by reference for all purposes in their entirety.

It would be highly desirable and advantageous to provide a hardfacing alloy composition and industrial products hard surfaced with it capable of having the exceptional combination of both high metal to metal wear resistance and extreme resistance to abrasion.

### BRIEF SUMMARY OF THE INVENTION

In one embodiment, the hardfacing alloy has an all weld metal composition undiluted by base metal by weight of about 0.45 to about 0.8 percent Carbon, about 3.5 to about 4.5 percent Boron, about 0.8 to about 1.25 percent Manganese, about 0.6 to about 0.8 percent Silicon, about 2.0 to about 2.5 percent Nickel, about 4.5 to about 6.5 percent Niobium, and the remainder Iron including impurities as trace elements. The hardfacing alloy in undiluted and as-welded condition has a hardness of from about 63 Rc (772 Hv) to 66 Rc (865 Hv). Its hardness, when welded in a single layer on a typical high Carbon tool steel joint, reaches about 64 Rc (800 Hv). It is further characterized by high abrasion resistance against silicious rock formations and particles, a low coefficient of friction resulting in excellent metal to metal use or resistance and very significant reduction in induced casing wear, and a boride quadratic crystallographic structure. The hardfacing alloy cracks form in a gradual manner as the weld transforms upon cooling from the liquid state through the plastic state; thus, the cracks are already formed upon solidification, which cracks are in vertical orientation and less subject to traveling in a horizontal plane which can induce spalling. It is capable of being welded in single or double layers. It can be deposited over preexistent weld deposits, such as tungsten carbide deposits and many other previous hardfacing and hardbanding deposits to which it can be welded with the exception of high chrome Iron overlays as described in U.S. Pat. No. 5,244,559.

In a second embodiment, the undiluted (all weld material) hardfacing alloy is substantially balanced between a primary austenitic phase and a secondary martensitic phase in approximately equal proportions in order to achieve an hypo-eutectic solidification mode. In a diluted single layer condition, the resulting microstructure is primarily a fine grained austenitic phase with a secondary martensitic phase in approximately equal proportions. The hardfacing alloy is particularly suited for welding on wear prone surfaces of tool joints and stabilizers (hardbanding) where it provides great protection from abrasion and has an optimum balance between the minimizing of induced casing wear and the maximizing of tool joint resistance in the casing. The hardfacing alloy may be positioned using a gas shielded metal-cored tubular wire.

In the second embodiment, the hardfacing alloy has an undiluted (all weld metal) composition by weight of about 0.9 to about 1.1 percent Carbon, about 1.1 to about 1.4 percent Manganese, about 1.1 to about 1.4 percent Nickel, about 2.0 to about 2.5 percent Niobium, and about 1.1 to about 1.5 percent Boron. The Silicon content, when deposits are made under CO₂ or 75 percent Argon and 25 percent CO₂ gas shields, is about 1 percent, and is considered incidental. The remainder is Iron (Fe), including impurities as trace elements. The hardfacing alloy in undiluted condition has a hardness of from about 53 Rc (565 Hv) to about 58 Rc (653 Hv), with about 55 Rc (590 Hv) average. Its hardness, when welded in a single layer (diluted) on a typical high Carbon tool steel joint, typically ranges from about 51 Rc (528 Hv) to about 55 Rc (590 Hv), with about 53 Rc (565 Hv) average. The undiluted alloy does not contain any substantial amount of Chromium. Nickel, Carbon and Boron are the primary alloying elements. The alloy has excellent abrasive wear resistance combined with excellent metal to metal wear resistance. The abrasion resistance as determined according to the ASTM G65 dry sand test is excellent, as is the metal to metal wear resistance. The hardbanding layers are substantially crack free using traditional hardbanding procedures. Advantageously, the hardfacing alloy can be positioned in single and double layers and on top of other pre-existing hardfacing alloys.

### BRIEF DESCRIPTION OF THE DRAWINGS

FIG. 1 is a fragmentary longitudinal sectional view of a box of a tool joint with a raised hardband.

FIG. 2 is a view similar to FIG. 1 illustrating a pin of the tool joint with a raised hardband.

FIG. 3 is a view similar to FIG. 1 illustrating flush hardbanding of a box of the tool joint.

FIG. 4 is a view similar to FIG. 1 illustrating flush hardbanding of a pin of the tool joint.

FIG. 5 is a longitudinal view of a stabilizer hardbanded.

FIG. 6 is a cross-sectional view of a cored wire with a butt seam joint.

FIG. 7 is a cross-sectional view of a cored wire with an overlap seam joint.

FIG. 8 is a diagrammatic view of apparatus suitable for welding a cored wire of the hardfacing alloy in open, gas shielded or submerged arc.

### DETAILED DESCRIPTION OF THE INVENTION

The first embodiment of the hardfacing composition comprises by weight about 0.45 to about 0.8 percent Carbon, about 3.5 to about 4.5 percent Boron, about 0.8 to about 1.25 percent Manganese, about 4.5 to about 6.5 percent Niobium, about 0.6 to about 0.8 percent Silicon, about 2.0 to about 2.5 percent Nickel, and the balance Iron with impurities as trace elements.

The first embodiment hardfacing alloy composition has an all weld hardness of from about 63 Rc (772 Hv) to 66 Rc (865 Hv), an average hardness single layer on industrial products, such as tool joints and drill stabilizers of about 595 Hv, a quadratic crystallographic boride and eutectic structure, a balance of metal to metal and abrasion resistance, and is capable of being deposited in single and double layers on top of itself or on pre-existent hardband alloys, such as tungsten carbide deposits.

The chemical analysis of an alloy composition of the first embodiment is set forth in the following table 1.

TABLE 1

| | |
|---|---|
| Carbon | 0.8% |
| Boron | 4.0% |
| Niobium | 5.5% |
| Nickel | 2.2% |
| Manganese | 1.0% |
| Silicon | 0.65% |

Remainder Iron (including trace elements as contaminants)

The hardfacing alloy set forth in Table 1 as welded to hardband tool joints, stabilizers, tubulars, casing, or hardfacing surfaces of other industrial products has the properties previously set forth, has a typical hardness as deposited of about 63 Rc (772 Hv) to about 66 Rc (865 Hv), has primary borides characterized by a quadratic structure as welded on a surface which while having cracks functions essentially as crack-free.

In a second embodiment, the hardfacing alloy has an undiluted (all weld metal) composition by weight of about 0.9 to about 1.1 percent Carbon (C), about 1.1 to about 1.4 percent Manganese (Mn), about 1.1 to about 1.4 percent Nickel (Ni), about 2.0 to about 2.5 percent Niobium (Nb), and about 1.1 to about 1.5 percent Boron (B). The Silicon (Si) content, when deposits are made under CO₂ or 75 percent Argon and 25 percent CO₂ gas shields, is about 1 percent, and is considered incidental. The remainder is Iron (Fe), including impurities as trace elements.

The hardfacing alloy of the second embodiment in undiluted condition has a hardness of from about 53 Rc (565 Hv) to about 58 Rc (653 Hv), with about 55 Rc (590 Hv) average. Its hardness, when welded in a single layer on a typical high Carbon tool steel joint, typically ranges from about 51 Rc (528 Hv) to about 55 Rc (590 Hv), with about 53 Rc (565 Hv) average. The undiluted alloy does not contain any substantial amount of Chromium. Nickel, Carbon, Boron and Niobium are the primary alloying elements. The alloy has excellent abrasive wear resistance combined with excellent metal to metal wear resistance. The abrasion resistance as determined according to the ASTM G65 dry sand test is excellent, as is the metal to metal wear resistance. The hardbanding layers are substantially crack free. The hardbanding alloy is capable of being positioned in single and double layers on top of itself or on pre-existing hardband alloys, such as tungsten carbide deposits. The hardbanding alloy does not require any post-weld heat treatments.

The chemical analysis of a preferred alloy composition of the second embodiment is set forth in the following table 2.

TABLE 2

| | |
|---|---|
| Carbon | 1.0% |
| Boron | 1.3% |
| Niobium | 2.25% |
| Nickel | 1.25% |
| Manganese | 1.2% |
| Silicon | 1.0% |

Remainder Iron (including trace elements as contaminants)

The hardfacing alloy set forth in Table 2 as welded to hardband tool joints, stabilizers, casing, tubulars, or hardfacing surfaces of other industrial products has the properties previously set forth, and has a typical hardness as deposited (diluted) of from about 51 Rc (528 Hv) to about 55 Rc (590 Hv), with about 53 Rc (565 Hv) average.

Industrial products as used herein include tool joints, drill collars, stabilizers and other components of drilling strings, as well as drill pipe, casing, and other tubulars used for earth boring. Other industrial products subject to abrasion are included as well. Examples of such industrial products are pressure vessels in the process industries, structural members in buildings and bridges, and down hole drilling equipment in the oil and gas industry. Other industrial applications and products include earthmoving and dredging equipment and components such as bucket teeth, gravel pump parts, crusher hammers, conveyor chains, gear teeth, and metal to metal sliding parts in the industry.

The hardfacing alloy composition of all embodiments is preferably deposited by metal cored tubular wire containing the hardfacing alloy used under gas shielding, such as CO₂, especially for tool joints and stabilizers, as well as other industrial applications including earthmoving and dredging equipment and components such as bucket teeth, gravel pump parts, crusher hammers, conveyor chains, gear teeth, and metal to metal sliding parts in the industry.

The development of a new Iron (Fe)-Boron based hardfacing alloy achieves an improved and better optimized balance between abrasive wear resistance and metal to metal wear resistance being particularly advantageous for tool-joint and stabilizer applications. In order to achieve this goal, an entirely novel approach was needed. The approach has consisted in the adoption of Boron instead of Carbon as the element of choice to ensure both the most appropriate microstructures and the required degrees of hardenability. Field experience in oil and gas drilling gained with the Cr-carbide and with the Martensitic-Austenitic alloys have demonstrated both its advantages and shortcomings.

Field testing, conducted on tool-joints of the Fe-Boron alloy, under conditions of drilling through various geological mineral formations from extremely abrasive to lesser abrasive ones, has demonstrated that the new approach which was adopted for the hardfacing alloys has enabled the accomplishment of the production of a hardfacing alloy capable of achieving an exceptional combination of both high metal to metal wear resistance and extreme resistance to abrasion. In this perspective, the field test results confirm the results of extensive preliminary laboratory testing of the Fe-Boron hardfacing alloy.

The properties of Boron as an alloying element have been exploited in a number of cases for achieving different objectives. These cases are however limited to low-alloyed carbon-steel weld metals in which Boron is used often in conjunction with Titanium to promote the formation of a particular type of phase known as acicular ferrite. The aim there was to achieve improved impact properties. The Boron additions were limited to a few parts per million (ppm).

Also, in high Carbon high alloyed Fe-based hardfacing weld metals, Boron has been used at levels of about up to 1 percent with the objective of strengthening the matrixes by induction of Martensitic types of transformation, but in all cases at the expense of a significant increase of the brittleness of the alloys especially when boron additions are combined with high Carbon contents.

Embodiments include the hardfacing alloy composition, tool joints, stabilizers, casing, and tubulars hardbanded with the hardfacing alloy composition. For example, tool joints which connect together drill pipe have an internally threaded box for reception of a threaded pin member, a cylindrical outer surface and a layer of the hardbanding alloy composition welded on the cylindrical outer surface, and on its pin member if desired, which provides tool joint protection from silicious abrasions. Also, stabilizers connected to drill pipe having stabilizer ribs hardbanded with the hardfacing composition which stabilize the drill pipe in the well bore and casing.

Other embodiments are industrial products having surfaces requiring high abrasion resistance hardfaced with the hardfacing alloy of the invention welded to their wear prone surface, such as abrasion resistance plates and other industrial structures requiring abrasion resistance, as previously set forth.

Different embodiments of hardfacing alloys for industrial uses are disclosed in which the hardfacing alloy is capable of withstanding silicious abrasion, and has an optimized balance between abrasive resistance and metal to metal resistance. The invention provides balanced metal to metal hardfacing alloys which can be utilized to hardband and thereby improve the service life of tool joints connecting drill pipe rotated and moved in casing in earth boring. The invention provides hardfacing alloys which can be utilized to hardband stabilizers which as welded withstands abrasion by silicious formations of the earth and other silicious materials with balanced metal to metal resistance.

The invention provides other industrial products subject to such abrasion having the hardfacing alloy welded on surfaces subject to such abrasion. The invention provides a hardfacing alloy for industrial products which have this abrasive resistant alloy welded on their abrasive prone surfaces, which has a low coefficient of fiction, excellent abrasion resistance, which in the case of tool joints and stabilizers achieves an optimum balance between the minimizations of induced casing wear in the bore hole, the maximization of tool joint wear resistance. Other and further objects, features, and advantages of embodiments of the invention appear throughout.

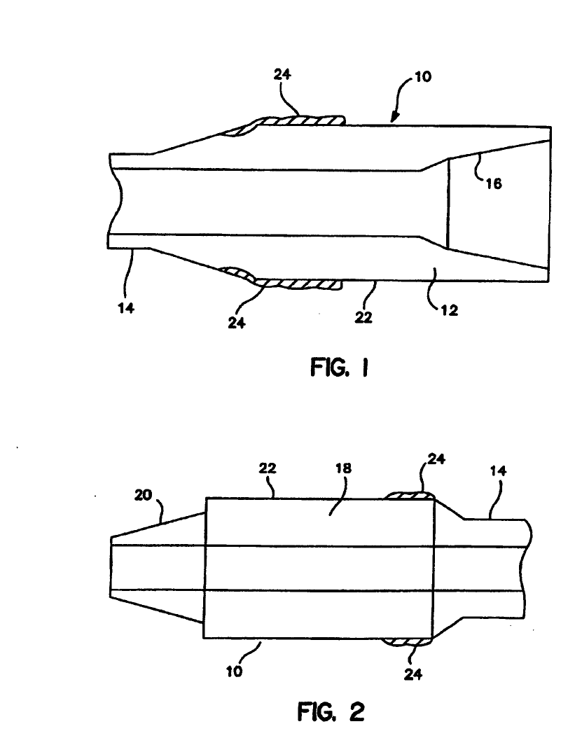

The following embodiment is a tool joint hardbanded with the essentially crack free hardfacing alloy. Referring now to FIGS. 1 and 2, a tool joint for drill pipe 10 is illustrated which has a box 12 at the end of the drilling pipe 14 which is internally threaded at 16 which threadedly receives a pin 18 having co-acting threads 20 to the threads 16 so that the pin 18 can be threaded into box 12. The pin 18 forms the end of a drill pipe, such as 14, so that a string or joints of pipe can be threadedly secured together and disconnected for drilling oil, gas, and other wells.

The box 12 and the pin 18 are enlarged and have a outer cylindrical surfaces 22 having an outer diameter greater than the outer diameter of the drill pipe 14 for deposit of the beads 24 of the hardbanding alloy.

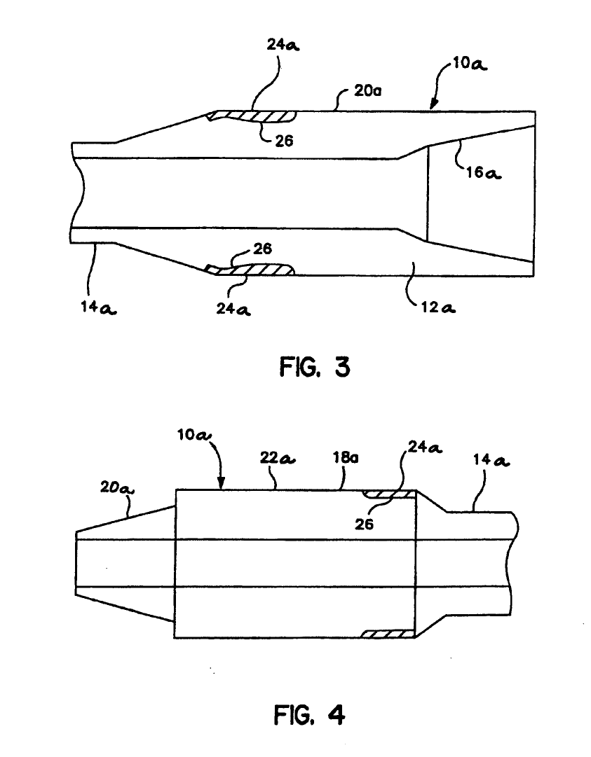

Referring now to FIGS. 3 and 4 where the reference letter “a” has been added to reference numerals corresponding to those in FIGS. 1 and 2, the tool joint lOa of FIGS. 3 and 4 is identical to that of the tool joint 10 of FIGS. 1 and 2 except that it has a reduced cylindrical portion 26 formed by either the removal of a circumferential band of material from the outer cylindrical surfaces 22a of the box 12a and the pin 18a or was originally formed with these reduced diameter sections 22a, and the hardbanding alloy in beads 24a is welded in this space so that the surface of the weld deposited hardfacing is substantially flush with the outer cylindrical surface of the box 12a and the pin 18a.

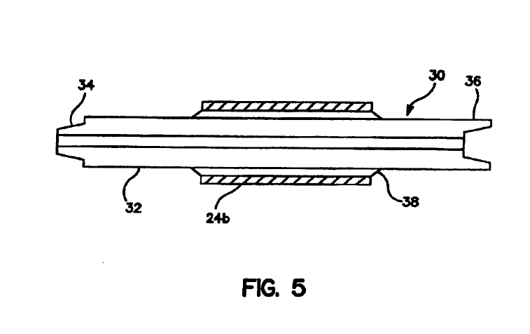

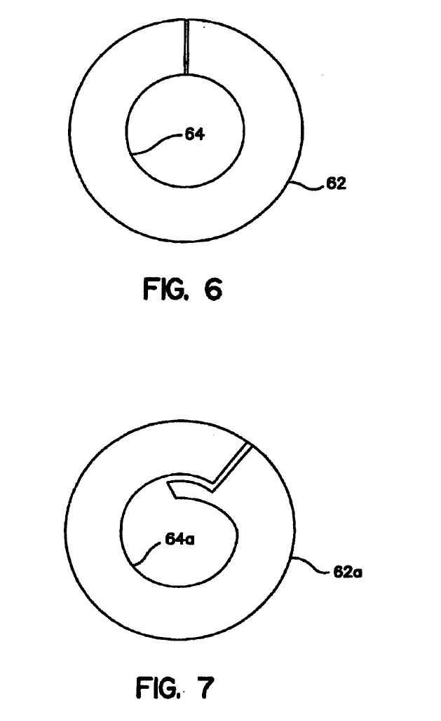

Referring to FIG. 5, a stabilizer 30 according to the invention is illustrated which has an elongated cylindrical or pipe-like body 32 having the pin 34 and box 36 for connection in a string of drill pipe (not shown), the stabilizer having the stabilizer ribs 38 extending outwardly from the body 32 for stabilizing the drill pipe in a well bore (not shown) to which the stabilizer ribs 38 the hardbanding alloy 24b is welded.

Referring now to FIGS. 6 and 7, tubular butt seam wires 62 and 62a having cores 64 and 64a of the weldable alloy composition are illustrated. In both cored tubular wires 62 and 62a, the cores 64 and 64a can be completely metallic powders, called metal cored, or a mixture of metal and mineral powders, called flux cored. In each case, the cored powders with the iron wire make up the alloy composition of the hardfacing or hardbanding alloy. Since cored wires are well known in the art and trade, no further description is given thereof or deemed necessary.

After long periods in service where abrasion by earth materials or silicious or other materials may abrade away an area of the hardfacing, additional hardbanding may be applied as indicated above without essential damage to the box 12 or pin 20 of the tool joint 10 and on the stabilizer ribs 38 of the stabilizer 30.

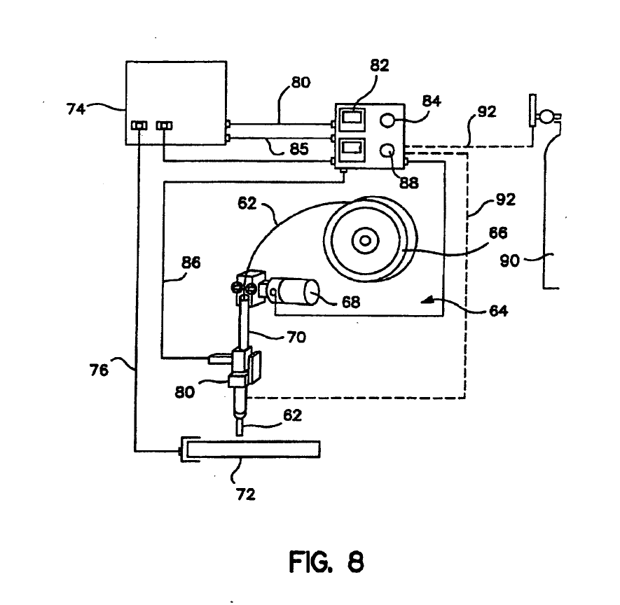

Referring now to FIG. 8 schematically illustrating apparatus useful in the method, the apparatus 64 includes a reel 66, a cored wire 62 (or 62a) wound around it, driven by the wire drive motor 68 through the guide tube 70 to the industrial product 72 to be hardfaced or hardbanded. A direct current, constant voltage power source 74 provides electrical energy through the electrical power cable 76 to the industrial product 72, and by the electric power cable 80 to the volt meter 82 and the voltage control 84. The electric cable 85 provides a voltage supply to the voltmeter and then through the electrode power cable 86 to the guide tube 70 and to the cored wire 62 or 62a.

When desired to be used, gas shielding is illustrated diagrammatically by the gas shielding source 90 through the gas tube 92 to the control switch 98 and to the guide tube 99 to provide shielding for electrodes requiring it.

The method for prolonging the surface life of tool joints, stabilizers, and other industrial products comprises hardfacing or hardbanding by tubular wire, in open arc, gas shielded or submerged arc, a layer of the hardbanding alloy 24, 24a, or 24b to the outer cylindrical surface 22 or 22a of the box 12 or 12a of the tool joints 10 and 10a (FIGS. 1, 2), the outer cylindrical surface 22 of the pin 18 (FIGS. 3 and 4) and the stabilizer ribs 38 (FIG. 5). Normally, the weld beads 24 of the hardbanding alloy are about 3/32 to ¼ inch thick without detriment to the alloy properties and can be deposited in single or double layers. If desired, the surfaces 22a of the weld beads 24 can be substantially flush with the surface of the box 12a, and about 3/32 inch of material is removed.

No more description is given or deemed necessary of apparatus for welding the alloy compositions of the tubular wire 52 or to such other apparatus and means to a surface to be hardfaced or hardbanded, as they are well known to those skilled in the art.

While the alloy is particularly suited for hardbanding tool joints and stabilizers, it may be applied to any surface requiring hardbanding or facing, such as structural members, process components, abrasion resistant plates, and the like.

The invention, therefore, is well suited and adapted to attain the objects and ends and has the advantages and features mentioned as well as others inherent therein.

While presently preferred embodiments of the invention have been given for the purposes of disclosure, changes may be made within the spirit of the invention as defined by the scope of the appended claims.

We claim:

1. An Iron based hardfacing alloy, said Iron based hardfacing alloy comprising by weight:
about 0.9 to about 1.1 percent Carbon, about 1.1 to about 1.5 percent Boron,
about 2.0 to about 2.5 percent Niobium, about 1.1 to about 1.4 percent Nickel,
and about 1.1 to about 1.4 percent Manganese.

2. The Iron based hardfacing alloy of claim 1, further comprising the balance by weight Silicon and Iron, including impurities as trace elements.

3. The Iron based hardfacing alloy of claim 2, further comprising by weight about 1.0 percent Silicon.

4. An Iron based hardfacing alloy, said Iron based hardfacing alloy comprising by weight:
about 0.9 to about 1.1 percent Carbon, about 1.1 to about 1.5 percent Boron,
about 2.0 to about 2.5 percent Niobium, about 1.1 to about 1.4 percent Nickel,
about 1.0 percent Silicon, and about 1.1 to about 1.4 percent Manganese.

5. The Iron based hardfacing alloy of claim 4, further comprising the balance by weight Iron, including impurities as trace elements.

6. An Iron based hardfacing alloy, said Iron based hardfacing alloy comprising by weight:
about 0.45 to about 0.8 percent Carbon, about 3.5 to about 4.5 percent Boron,
about 0.8 to about 1.25 percent Manganese and about 0.6 to about 0.8 percent Silicon.

7. The Iron based hardfacing alloy of claim 6, further comprising the balance by weight Nickel, Niobium and Iron, including impurities as trace elements.

8. An industrial product having a surface subject to abrasion, comprising:
an Iron based hardfacing alloy comprising by weight about 0.9 to about 1.1 percent Carbon, about 1.1 to about 1.5 percent Boron, about 2.0 to about 2.5 percent Niobium, about 1.1 to about 1.4 percent Nickel, and about 1.1 to about 1.4 percent Manganese,
said Iron based hardfacing alloy positioned on the surface of the industrial product subject to said abrasion.

9. The product of claim 8, wherein said Iron based hardfacing alloy further comprising the balance by weight Silicon and Iron, including impurities as trace elements.

10. The product of claim 9, wherein said Iron based hardfacing alloy further comprising about 1.0 percent Silicon.

11. A tool joint internally threaded box which has an outer cylindrical surface, comprising:
an Iron based hardfacing alloy comprising by weight about 0.9 to about 1.1 percent Carbon, about 1.1 to about 1.5 percent Boron, about 2.0 to about 2.5 percent Niobium, about 1.1 to about 1.4 percent Nickel, and about 1.1 to about 1.4 percent Manganese,
said Iron based hardfacing alloy positioned on said outer cylindrical surface of said box, and
said Iron based hardfacing alloy thereby providing surface resistance to abrasion.

12. The tool joint box of claim 11, wherein said Iron based hardfacing alloy further comprising the balance by weight Silicon and Iron, including impurities as trace elements.

13. The tool joint box of claim 11 wherein:
the outer cylindrical surface of said box has a reduced diameter portion extending along a portion of its length, and
said Iron based hardfacing alloy positioned on said reduced diameter portion.

14. The tool joint of claim 13, wherein said Iron based hardfacing alloy further comprising the balance by weight Silicon and Iron, including impurities as trace elements.

15. The tool joint of claim 14, wherein said Iron based hardfacing alloy further comprising about 1.0 percent Silicon.

16. A method of prolonging the life of an industrial product having a surface subject to abrasion, comprising:
positioning a layer of an Iron based hardfacing alloy to a portion of the surface of the industrial product subject to the abrasion,
said Iron based hardfacing alloy comprising by weight about 0.9 to about 1.1 percent Carbon, about 1.1 to about 1.5 percent Boron, about 2.0 to about 2.5 percent Niobium, about 1.1 to about 1.4 percent Nickel, and about 1.1 to about 1.4 percent Manganese.

17. The method of claim 16, wherein said Iron based hardfacing alloy further comprising the balance by weight Silicon and Iron, including impurities as trace elements.

18. The method of claim 17, wherein said Iron based hardfacing alloy further comprising about 1.0 percent Silicon.

19. The method of claim 16, further comprising a cored tubular wire wherein:
said Iron based hardfacing alloy is in said tubular wire.

20. The method of claim 16, wherein said step of positioning comprising welding.
